(19) United States
(12) Patent Application Publication
(10) Pub. No.: US 2019/0211205 A1
(43) Pub. Date: Jul. 11, 2019

(54) POLYLACTIC ACID COMPOSITION AND MANUFACTURING METHOD OF POLYLACTIC ACID MOLDED ARTICLE

(71) Applicant: AGT GREEN TECHNOLOGY CO., LTD., Taoyuan City (TW)

(72) Inventors: Chia-Yen Lee, TAOYUAN CITY (TW); Fumimasa KISE, Nogo City (JP); Shi-Yi Chin, Taipei City (TW)

(21) Appl. No.: 15/868,982

(22) Filed: Jan. 11, 2018

(51) Int. Cl. C08L 67/04; B29C 45/00; B29B 9/00; B29C 45/73

(52) U.S. Cl. CPC C08L 67/04; B29C 45/0001; B29B 9/00; B29K 2067/046; C08L 2205/025; C08L 2205/24; C08L 2207/20; B29C 45/7312

(57) ABSTRACT

A manufacturing method of a polylactic acid molded article includes implementing a granulating step and a forming step. The granulating step includes: mixing a polylactic acid material, a polylactic acid recovery material having a weight average molecular weight less than that of the polylactic acid material, and a crystallizing agent in an environment of 180□ to 250□; carrying out a first molecular chains recombination of the polylactic acid material and the polylactic acid recovery material; and forming a polylactic acid composition after granulation. The forming step includes: filling the polylactic acid composition into a mold with an injection molding machine; carrying out a second molecular chains recombination of the polylactic acid composition in the mold; and forming the polylactic acid molded article after curation. The present disclosure also provides a polylactic acid composition.

### BACKGROUND OF THE INVENTION

### 1. Field of the Invention

The present disclosure relates to a polylactic acid composition and a manufacturing method of a polylactic acid molded article; in particularly to, a polylactic acid composition and a manufacturing method of a polylactic acid molded article using a polylactic acid recovery material.

### 2. Description of Related Art

In general, there are three ways in which recycling industries deal with recycled wastes, including burial, incineration, and recycling. For the biodegradable polylactic acid, the best way to deal with it should be burial based on its biodegradable properties, and the polylactic acid is gradually degraded to be carbon dioxide and water in a natural environment so that the purpose of pollution-free can be achieved. However, considering the degradation condition of the polylactic acid, the polylactic acid takes about three to six months to be completely degraded under specific composting conditions (i.e. a humidity of more than 90%, a temperature of 58-70□, and a non-closed environment), and takes about three years to be gradually degraded under general soil burial conditions. Accordingly, if the polylactic acid recovery materials are treated by the way of burial, a vast land will be needed; and if the polylactic acid recovery materials are treated by the way of incineration, it will not only cause the problem of air pollution, but also lose the advantage of the biodegradable properties of the polylactic acid. Therefore, the developments of recovery and remanufacturing technologies of the polylactic acid in solving the treatment difficulties in the polylactic acid recovery materials are necessary. However, there is currently no suitable recovery and remanufacturing technology for treating the polylactic acid recovery materials, so that the polylactic acid recovery materials with an increasing amount are becoming more and more difficult to deal with.

In addition, the conventional manufacturing method of the polylactic acid molded article often produces a lot of unqualified molded articles, scrap materials, and waste materials (that is, the polylactic acid recovery materials), and these unqualified molded articles, scrap materials, and waste materials are naturally degraded by the way of burial. This approach wastes a lot of resources. Therefore, the treatment for these unqualified molded articles, scrap materials, and waste materials, has been a matter of great concern to those skilled in the art.

In this regards, the present disclosure provides a polylactic acid composition and a manufacturing method of a polylactic acid molded article to overcome the aforementioned drawbacks.

### SUMMARY OF THE INVENTION

The object of the present disclosure is to provide a polylactic acid composition and a manufacturing method of a polylactic acid molded article, which are capable of effectively repeating the use of unqualified molded articles, scrap materials, and waste materials (that is, the polylactic acid recovery materials).

In order to achieve the object of the present disclosure, the manufacturing method of the polylactic acid molded article includes implementing a granulating step and a forming step. The granulating step includes: mixing a polylactic acid material, a polylactic acid recovery material having a weight average molecular weight less than that of the polylactic acid material, and a crystallizing agent in an environment of 180□ to 250□; carrying out a first molecular chains recombination of the polylactic acid material and the polylactic acid recovery material; and forming a polylactic acid composition after granulation. The forming step includes: filling the polylactic acid composition into a mold with an injection molding machine; carrying out a second molecular chains recombination of the polylactic acid composition in the mold; and forming the polylactic acid molded article after curation.

In one preferred embodiment of the present disclosure, the polylactic acid material is an L-type polylactic acid (PLLA), and the crystallizing agent is a food grade crystallizing agent.

In one preferred embodiment of the present disclosure, the weight average molecular weight of the polylactic acid recovery material is less than 50% of the weight average molecular weight of the polylactic acid material.

In one preferred embodiment of the present disclosure, based on the total weight of the polylactic acid material and the polylactic acid recovery material in an amount of 100 parts by weight, the polylactic acid recovery material is used in an amount of 30 to 70 parts by weight and the crystallizing agent is used in an amount of 0.1 to 1 parts by weight.

In one preferred embodiment of the present disclosure, the mold is provided with a cooling water channel structure so that the temperature in the mold is substantially uniform; and in the forming step, the second molecular chains recombination of the polylactic acid composition is carried out by the injection molding machine and the cooling water channel structure.

In one preferred embodiment of the present disclosure, the polylactic acid composition does not contain any lubricant or plasticizer.

The polylactic acid composition of the present disclosure includes: a polylactic acid material; a polylactic acid recovery material having a weight average molecular weight less than that of the polylactic acid material, and the polylactic acid recovery material used in an amount of 30 to 70 parts by weight based on the total weight of the polylactic acid material and the polylactic acid recovery material in an amount of 100 parts by weight; and a crystallizing agent used in an amount of 0.1 to 1 parts by weight.

In one preferred embodiment of the present disclosure, the weight average molecular weight of the polylactic acid recovery material is less than 50% of the weight average molecular weight of the polylactic acid material.

In one preferred embodiment of the present disclosure, the polylactic acid material is an L-type polylactic acid (PLLA), and the crystallizing agent is a food grade crystallizing agent.

In one preferred embodiment of the present disclosure, the polylactic acid composition does not contain any lubricant or plasticizer.

As described above, the polylactic acid composition and the manufacturing method of the polylactic acid molded article of the present disclosure enable the crystallinity of the polylactic acid molded article to be effectively increased by the two-stage molecular chains recombination and the crystal nuclei formed by the crystallizing agent in the granulating step, thereby improving the heat resistance and the durability of the polylactic acid molded article.

For further understanding of the present disclosure, the following embodiments are provided to facilitate the disclosure of the present disclosure.

### DETAILED DESCRIPTION OF PREFERRED EMBODIMENTS

The aforementioned illustrations and following detailed descriptions are exemplary for the purpose of further explaining the scope of the instant disclosure. Other objectives and advantages related to the instant disclosure will be illustrated in the subsequent descriptions and appended drawings. In addition, for an easy instruction, similar reference numbers or symbols refer to elements alike.

The present embodiment discloses a manufacturing method of a polylactic acid molded article. The polylactic acid molded article is preferably a food utensil (a cup, a bowl, a knife, a fork, a spoon, a plate, a crisper, etc.). Accordingly, in the above manufacturing method of the polylactic acid molded article, no any lubricant or plasticizer is used so that the polylactic acid molded article is fully made of natural materials and does not cause any burden to the human body.

The manufacturing method of the polylactic acid molded article of the present embodiment includes a material selecting step, a granulating step, and a forming step. Hereinafter, the above-mentioned material selecting step, the granulating step, and the forming step will be described, but the manufacturing method of the polylactic acid molded article of the present disclosure is not limited thereto.

### Material Selecting Step

The material selecting step of the present embodiment includes: selecting a polylactic acid material, a polylactic acid recovery material having a weight average molecular weight less than that of the polylactic acid material, and a crystallizing agent.

The polylactic acid material is selected from a commercially available polylactic acid material having a weight average molecular weight ranging from about 80,000 to 300,000. The polylactic acid material of the present embodiment is preferably selected from a low cost L-type polylactic acid (PLLA), but the present disclosure is not limited thereto.

The polylactic acid recovery material is an unqualified molded article, a scrap material, a waste material, or an abandoned polylactic acid molded article produced by the above manufacturing method of the polylactic acid molded article. The weight average molecular weight of the polylactic acid recovery material is preferably less than 50% of the weight average molecular weight of the polylactic acid material.

The crystallizing agent is selected from the group consisting of inorganic crystalline nucleating agents or organic crystalline nucleating agents. The crystallizing agent of the present embodiment is preferably selected from a food grade crystallizing agent, such as an organophosphate compound, an organic amide compound, an organic hydrazide compound, an organic sulfonate compound, a phthalocyanine compound, and a sorbitol compound. The above-mentioned crystallizing agents can be used singly or in a combination of two or more.

In terms of the usage amount of each material, based on the total weight of the polylactic acid material and the polylactic acid recovery material in an amount of 100 parts by weight, the polylactic acid recovery material is used in an amount of 30 to 70 parts by weight and the crystallizing agent is used in an amount of 0.1 to 1 parts by weight. It is worth mentioning that the materials selected in the present embodiment are preferably not including any lubricant or plasticizer.

Preferably, the material selecting step further includes: crushing the polylactic acid recovery material by a crusher prior to the granulating step so that the polylactic acid recovery material can be uniformly mixed with the polylactic acid material; and dehumidifying and drying the polylactic acid material, the polylactic acid recovery material, and the crystallizing agent so that the water content of each material can be reduced and the hydrolysis reaction can be avoided in the subsequent steps, but the present disclosure is not limited thereto. For example, in another embodiment of the present disclosure, the polylactic acid recovery material needs not be crushed by a crusher, or the above-mentioned materials need not be dehumidified and dried.

### Granulating Step

The granulating step of the present embodiment includes: mixing the polylactic acid material, the polylactic acid recovery material, and the crystallizing agent in an environment of a high temperature; carrying out a first molecular chains recombination of the polylactic acid material and the polylactic acid recovery material; and forming a polylactic acid composition after granulation.

More specifically, the granulating step of the present embodiment includes: mixing the polylactic acid material, the polylactic acid recovery material, and the crystallizing agent in a mixing apparatus according to the usage amount of each material described above so that the above materials can be uniformly mixed with each other and can form a polylactic acid pre-composition; and cooling the polylactic acid pre-composition (i.e. through a cooling water tank) to granulate and form a polylactic acid composition. Preferably, the operating temperature of the mixing apparatus is ranging from 180□ to 250□, and the mixing apparatus is, for example, a brabender mixer or a twin screw extruder, but the present disclosure is not limited thereto.

Further, the polylactic acid material and the polylactic acid recovery material are in the molten state at the high temperature of 180□ to 250□ (above the melting point). At this time, the kinetic energy of the polymer chains increases, the moving speed of the polymer chains is accelerated, and the polymer chains will be partially broken. The broken polymer chains are recombined with other polymer chains to carry out the first molecular chains recombination so that the polylactic acid material and the polylactic acid recovery material can be uniformly mixed with each other.

In addition, the crystallizing agent can enable the polylactic acid pre-composition to undergo a first crystallization in the cooling process and produce crystal nuclei having particle sizes smaller than the visible wavelength and the high temperature resistance. The crystal nuclei will not be molten in the subsequent high temperature process, and thus can be used as the crystal nuclei of a second crystallization (such as the forming step described below).

### Forming Step

The forming step of the present embodiment includes: filling the polylactic acid composition into a mold with an injection molding machine; carrying out a second molecular chains recombination of the polylactic acid composition in the mold; and forming the polylactic acid molded article after curation.

More specifically, the forming step of the present embodiment includes: filling the polylactic acid composition into the mold with the injection molding machine in a high operating temperature range (i.e. 170□ to 220□) and a high operating pressure range (i.e. 40 kg/cm² to 100 kg/cm²). Preferably, the periphery of the mold is provided with a cooling water channel structure so that the temperature in the mold is substantially uniform.

Further, the high temperature, at which the polylactic acid composition is brought into contact with the injection molding machine, can cause the polymer chains to be partially broken again. The broken polymer chains are recombined with other polymer chains to carry out the second molecular chains recombination. Meanwhile, the polylactic acid composition can be uniformly cooled by the cooling water channel structure, and the polylactic acid composition undergoes the second crystallization in the cooling process so as to form the polylactic acid molded article. It is worth mentioning that since the crystal nuclei produced during the first crystallization in the granulating step are still present in the entire reaction system, the crystal nuclei can be used as the crystal nuclei of the second crystallization, so that the cured polylactic acid molded article has a high degree of crystallinity.

Therefore, the polylactic acid composition and the manufacturing method of the polylactic acid molded article of the present disclosure enable the crystallinity of the polylactic acid molded article to be effectively increased by the two-stage molecular chains recombination and the crystal nuclei formed by the crystallizing agent in the granulating step, thereby improving the heat resistance and the durability of the polylactic acid molded article.

### Polylactic Acid Composition

The above description is the manufacturing method of the polylactic acid molded article according to the embodiment of the present disclosure. Hereinafter, the polylactic acid composition (or the polylactic acid molded article) of the present embodiment will be described briefly.

The polylactic acid composition (or the polylactic acid molded article) includes a polylactic acid material, a polylactic acid recovery material, and a crystallizing agent. Preferably, the polylactic acid composition (or the polylactic acid molded article) does not contain any lubricant or plasticizer. The polylactic acid material is an L-type polylactic acid (PLLA), and the crystallizing agent is a food grade crystallizing agent.

Further, the weight average molecular weight of the polylactic acid recovery material is less than that of the polylactic acid material. Preferably, the weight average molecular weight of the polylactic acid recovery material is less than 50% of the weight average molecular weight of the polylactic acid material.

In addition, based on the total weight of the polylactic acid material and the polylactic acid recovery material in an amount of 100 parts by weight, the polylactic acid recovery material is used in an amount of 30 to 70 parts by weight and the crystallizing agent is used in an amount of 0.1 to 1 parts by weight.

### Advantageous Effect of the Present Disclosure

As described above, the polylactic acid composition and the manufacturing method of the polylactic acid molded article of the present disclosure can efficiently reproduce the polylactic acid recovery material (i.e. the unqualified molded article, the scrap material, the waste material, or the abandoned polylactic acid molded article) to be a new polylactic acid molded article by the material selecting step, granulating step, and the forming step, thus avoiding the need to deal with these polylactic acid recovery materials by the way of burial.

Further, the polylactic acid composition and the manufacturing method of the polylactic acid molded article of the present disclosure enable the crystallinity of the polylactic acid molded article to be effectively increased by the two-stage molecular chains recombination and the crystal nuclei formed by the crystallizing agent in the granulating step, thereby improving the heat resistance and the durability of the polylactic acid molded article.

Moreover, the polylactic acid composition and the manufacturing method of the polylactic acid molded article of the present disclosure are not including any lubricant or plasticizer so that the polylactic acid molded article is fully made of natural materials and does not cause any burden to the human body.

In addition, the polylactic acid material of the present disclosure is selected from the low cost L-type polylactic acid (PLLA), and the polylactic acid recovery material of the present disclosure is the unqualified molded article, the scrap material, the waste material, or the abandoned polylactic acid molded article produced by the above manufacturing method, so that the manufacturing cost of the polylactic acid molded article can be reduced, and the purposes of waste recycling, environmental protection, and energy saving can be achieved.

Finally, the polylactic acid molded article of the present disclosure can be used as the polylactic acid recovery material in the above manufacturing method when it is discarded so that the polylactic acid recovery material can be repeatedly recovered and reused.

The descriptions illustrated supra set one simply the preferred embodiment of the present disclosure; however, the characteristics of the present disclosure are by no means restricted thereto. All changes, alterations, or modifications conveniently considered by those skilled in the art are deemed to be encompassed within the scope of the present disclosure delineated by the following claims.

What is claimed is:

1. A manufacturing method of a polylactic acid molded article, comprising:
implementing a granulating step including: mixing a polylactic acid material, a polylactic acid recovery material having a weight average molecular weight less than that of the polylactic acid material, and a crystallizing agent in an environment of 180□ to 250□; carrying out a first molecular chains recombination of the polylactic acid material and the polylactic acid recovery material; and forming a polylactic acid composition after granulation: and
implementing a forming step including: filling the polylactic acid composition into a mold with an injection molding machine; carrying out a second molecular chains recombination of the polylactic acid composition in the mold; and forming the polylactic acid molded article after curation.

2. The manufacturing method of the polylactic acid molded article according to claim 1, wherein the polylactic acid material is an L-type polylactic acid (PLLA), and the crystallizing agent is a food grade crystallizing agent.

3. The manufacturing method of the polylactic acid molded article according to claim 1, wherein the weight average molecular weight of the polylactic acid recovery material is less than 50% of the weight average molecular weight of the polylactic acid material.

4. The manufacturing method of the polylactic acid molded article according to claim 1, wherein, based on the total weight of the polylactic acid material and the polylactic acid recovery material in an amount of 100 parts by weight, the polylactic acid recovery material is used in an amount of 30 to 70 parts by weight and the crystallizing agent is used in an amount of 0.1 to 1 parts by weight.

5. The manufacturing method of the polylactic acid molded article according to claim 1, wherein the mold is provided with a cooling water channel structure so that the temperature in the mold is substantially uniform; wherein, in the forming step, the second molecular chains recombination of the polylactic acid composition is carried out by the injection molding machine and the cooling water channel structure.

6. The manufacturing method of the polylactic acid molded article according to claim 1, wherein the polylactic acid composition does not contain any lubricant or plasticizer.

7. A polylactic acid composition, comprising:
a polylactic acid material;
a polylactic acid recovery material having a weight average molecular weight less than that of the polylactic acid material, and the polylactic acid recovery material used in an amount of 30 to 70 parts by weight based on the total weight of the polylactic acid material and the polylactic acid recovery material in an amount of 100 parts by weight; and
a crystallizing agent used in an amount of 0.1 to 1 parts by weight.

8. The polylactic acid composition according to claim 7, wherein the weight average molecular weight of the polylactic acid recovery material is less than 50% of the weight average molecular weight of the polylactic acid material.

9. The polylactic acid composition according to claim 7, wherein the polylactic acid material is an L-type polylactic acid (PLLA), and the crystallizing agent is a food grade crystallizing agent.

10. The polylactic acid composition according to claim 7, wherein the polylactic acid composition does not contain any lubricant or plasticizer.
